(19) United States
(12) Patent Application Publication
(10) Pub. No.: US 2014/0251215 A1
(43) Pub. Date: Sep. 11, 2014

(54) EXCHANGEABLE CARTRIDGE SYSTEM FOR PRODUCTION COATER

(71) Applicants: Timothy C. PILIPAUSKAS, Arlington Heights, IL (US); Michael Tanaka, Barrington, IL (US)

(72) Inventors: Timothy C. PILIPAUSKAS, Arlington Heights, IL (US); Michael Tanaka, Barrington, IL (US)

(21) Appl. No.: 14/198,703

(22) Filed: Mar. 6, 2014

Related U.S. Application Data
(60) Provisional application No. 61/773,443, filed on Mar. 6, 2013.

(51) Int. Cl. B05B 13/02; B05C 11/08

(52) U.S. Cl. CPC B05B 13/0257; B05C 11/08
USPC 118/713; 118/418; 118/75; 118/303

(57) ABSTRACT

An exchangeable cartridge system for use with a production coater for coating a material with a solution or a suspension. The exchangeable cartridge system includes an integrated drum and exhaust plenum, the drum is connectable with a motor of the production coater and the exhaust plenum is connectable with an exhaust duct of the production coater. The exchangeable cartridge system provides for simple exchange of drums having a wide range of production capacities.

### CROSS REFERENCE TO RELATED APPLICATION

This Application claims the benefit of U.S. Provisional Patent Application Ser. No. 61/773,443, filed on 6 Mar. 2013. The co-pending U.S. Provisional Patent Application is hereby incorporated by reference herein in its entirety and is made a part hereof, including but not limited to those portions which specifically appear hereinafter.

### BACKGROUND OF THE INVENTION

1. Field of the Invention

This invention relates to an exchangeable cartridge system for a production coater for coating a material with a solution or a suspension. More specifically, the invention relates to the exchangeable cartridge system having an integral exhaust plenum and a drum that can be removably connected to the production coater and swapped for another exchangeable cartridge system with an exhaust plenum and a different sized drum.

2. Description of Prior Art

Fully-perforated side-vented coating pans and coaters have been in use since the early 70's. In the past, such coaters for coating pharmaceuticals and other substrates were expensive, complex, difficult to clean and included a multiplicity of parts. The apparatus of the prior art are inherently expensive, inflexible, difficult to operate properly, difficult to clean and sized to a specific application. Traditional coaters can only adapt to a single coating drum resulting in an inability to handle a wide range of processes and batch sizes in a single coater.

A problem associated with conventional coating apparatus for coating a material with a solution is that they require complex and single-purposed apparatus. Another problem associated with conventional coating apparatus for coating a material with a solution is that they require the use of equipment that are not easily cleaned. Still another problem associated with conventional coating apparatus for coating a material with a solution is that they cannot be disassembled quickly without the use of hand tools or other tools. More specifically, existing coaters include coating drums that are difficult, if not impossible, to extract and/or insert. Yet a further problem associated with conventional coating apparatus is that they foul with product build-up and tend to disrupt the coating process, adversely affecting product quality and thereby leading to disqualified or discarded batches.

For the foregoing reasons, there has been defined a long felt and unsolved need for a coating apparatus for coating a material to be coated with a solution that is easily installed, comparatively inexpensive to manufacture and maintain and adjustable to accommodate a variety of applications. In contrast to the foregoing, the present invention constitutes a coating apparatus for coating a material to be coated with a solution that seeks to overcome the problem discussed above while at the same time providing a simple relatively easily constructed apparatus and method that is readily adapted to a variety of applications.

### SUMMARY OF THE INVENTION

A universal exchangeable cartridge of this invention, with an integral exhaust plenum and a drum, is preferably for use with a production coater with exchangeable drums, for example the production coater with exchangeable drums described in U.S. patent application Ser. No. 12/493,710, filed on 29 Jun. 2009. U.S. patent application Ser. No. 12/493,710 is hereby incorporated by reference in its entirety.

In an embodiment of this invention, the production coater for coating a material with a solution or a suspension includes a housing and a drive motor to rotate an internal coating drum, referred to as a “drum” herein, to coat cores or other material to be coated with the solution or suspension. The drum is preferably a component of an exchangeable cartridge that is removably connectable to the drive motor. The exchangeable cartridge system of this invention is designed to decrease changeover time of the drum and to improve cleanability of the production coater.

In a preferred embodiment of this invention, the exchangeable cartridge system includes an exhaust plenum integral to the exchangeable drum allowing the exhaust plenum and the drum to be extracted from the production coater as a single unit simplifying changeover. The exchangeable cartridge may further include a cradle to support the exhaust plenum and the drum in order to simplify the attachment and extraction of the drum to the production coater. The cradle preferably includes a plurality of rollers to simplify movement of the exchangeable cartridge.

In an embodiment of this invention, the exhaust plenum is connected to the drum to provide a path for exhaust to be vented from an interior of the drum, for example through a vented surface and/or perforated surface of the drum to an exterior of the production coater for treatment, re-use and/or disposal. The exhaust plenum is preferably removably connectable to an exhaust duct of the production coater to allow the exhaust to be expelled from the production coater. In an embodiment of this invention, the exhaust plenum includes a pair of side walls, a rear wall and a facing wall that provide an enclosed path from the drum to the exhaust duct. The pair of side walls, the rear wall and the facing wall form an opening which faces the vented surface of the drum. The walls further enclose an exhaust path from the drum to the exhaust duct. In an embodiment of this invention, an exhaust opening is connected to at least one of the pair of side walls, the rear wall, and the facing wall to provide a connection to the exhaust duct. In a preferred embodiment, the opening which faces the drum further includes a side seal, also known as a rib, and a horizontal seal surrounding the opening to enclose a gap between the exhaust plenum and the drum to prevent the exhaust plenum from bypassing air from outside of the drum rather than through perforations in the drum and to prevent the exhaust from escaping the exhaust plenum into an interior of the production coater. In a preferred embodiment, the side seal comprises a pair of pair of side seals, each side seal orientated vertically and connected to one of the pair of side walls to at least partially close off an edge of the drum. In a preferred embodiment, the horizontal seal comprises an upper horizontal seal and a lower horizontal seal. Each of the upper seal and the lower seal are positioned between the pair of side walls at an upper and lower edge of the opening between the exhaust plenum and the drum when the exhaust plenum is adjacent to the drum. In an embodiment of this invention, at least one of the side seals, the upper seal and the lower seal is moveable to improve cleanability of the production coater and to ensure proper water drainage during a washing cycle.

In an embodiment of this invention, the exhaust plenum is repeatably connectable and disconnectable with the exhaust duct. In a preferred embodiment, the exhaust plenum and the exhaust duct include a toggle type over-the-center clamps which may be manually actuated after docking.

In a preferred embodiment, the exhaust plenum may further include an inspection door in one of the pair of side walls, the rear wall and the facing wall to allow for inspection of the interior of the exhaust plenum.

### BRIEF DESCRIPTION OF THE DRAWINGS

These and other objects and features of this invention will be better understood from the following detailed description taken in conjunction with the following generalized and simplified drawings, wherein:

FIG. 1 is a perspective view of a production coater with an exchangeable cartridge according to one preferred embodiment of this invention.

FIG. 2 is a perspective view of the production coater of FIG. 1 with a main door closed.

FIG. 3 is a side view of the exchangeable cartridge according to one embodiment of this invention.

FIG. 4 is a side view of a drum according to one embodiment of this invention.

FIG. 5 is a perspective view of an exhaust plenum according to one embodiment of this invention.

FIG. 6 is another perspective view of the exhaust plenum shown in FIG. 5.

FIG. 7 is a perspective view of an embodiment of the exchangeable cartridge being inserted into the production coater.

FIG. 8 is another perspective view of the exchangeable cartridge being inserted into the production coater.

FIG. 9 is another perspective view of the exchangeable cartridge being inserted into the production coater.

FIG. 10 is a perspective view of another embodiment of the exchangeable cartridge of this invention positioned on a dolly.

### DETAILED DESCRIPTION OF THE INVENTION

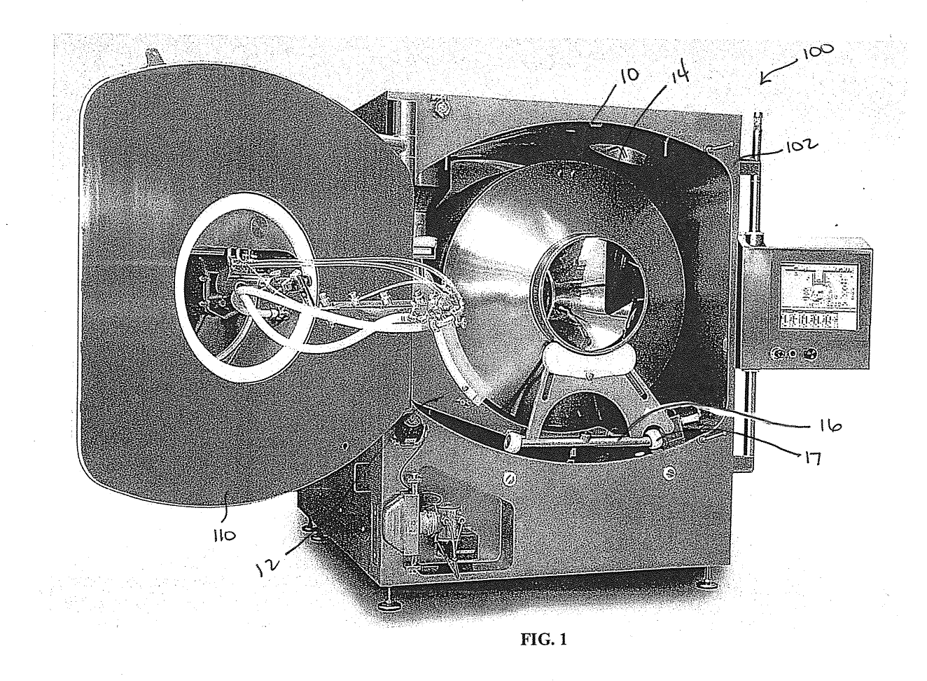

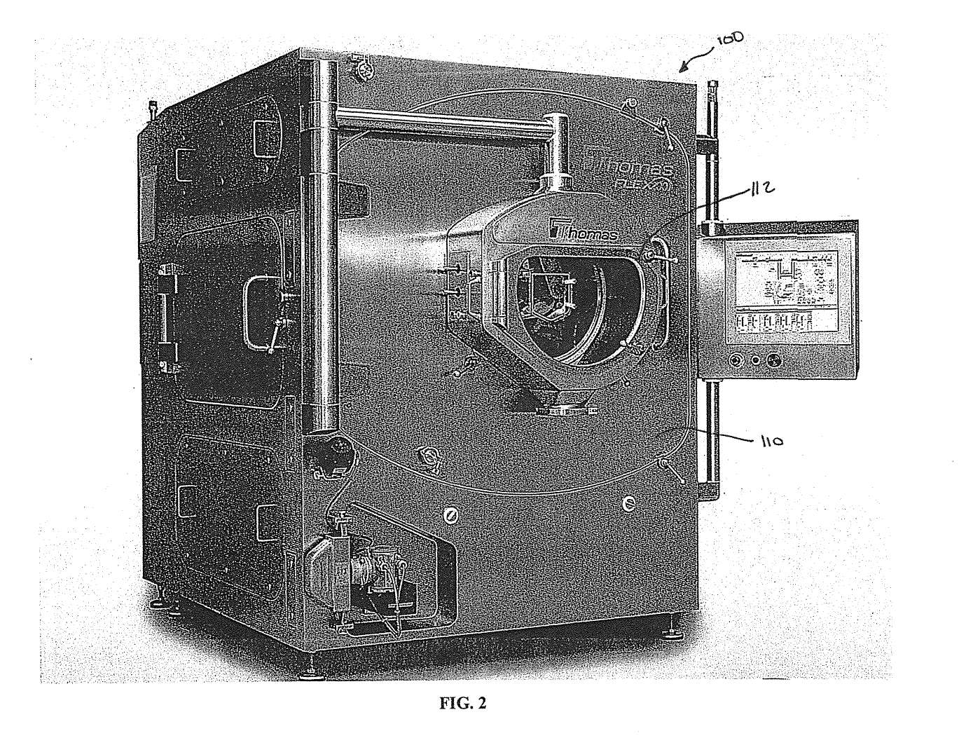

FIGS. 1 and 2 show a production coater 100 with an exchangeable cartridge system 10 according to one embodiment of this invention. The production coater 100 is a machine for coating pharmaceutical tablets and similar applications, preferably with a solution or a suspension. The production coater 100 is preferably a production scale coater capable of production in the range of approximately 30 liters to approximately 1,200 liters of material per batch. However, the coater 100 should not be limited to this range and may comprise of any volume. The coater 100 preferably includes a housing 102 and a motor, not shown, capable of rotating the exchangeable cartridge system 10. As shown in FIG. 2, the housing 102 is preferably configured to provide a sealed, sanitary enclosure for the mixing and coating operation. According to a preferred embodiment of this invention, the production coater 100 may further include front access to an interior of the housing 102 through access door 110 and/or process port 112 positioned within access door 110. In such a manner, the front of coater 100 preferably opens to provide full access to the exchangeable cartridge 10 for extraction, insertion, inspection, baffles access, cleaning, maintenance and cleaning validation.

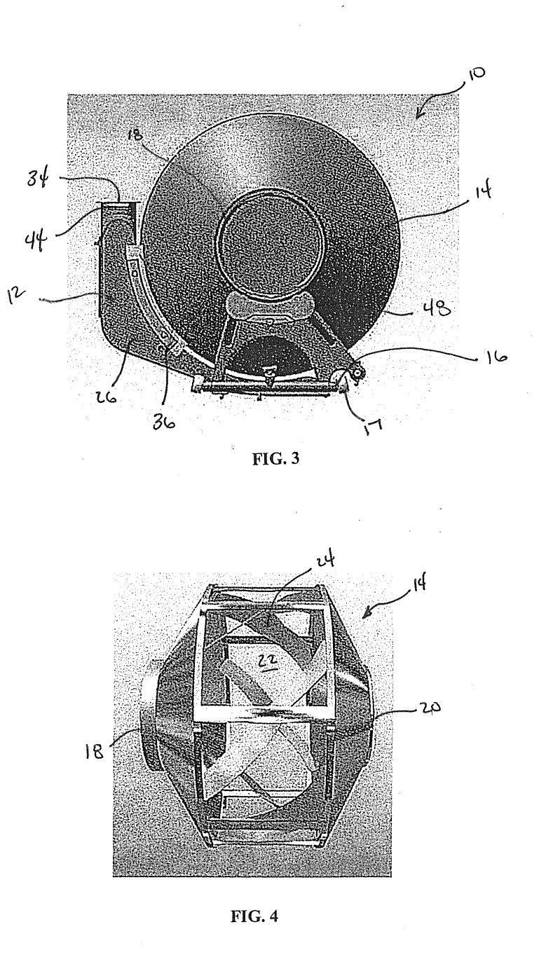

As shown in the embodiment of FIG. 3, the exchangeable cartridge system 10 includes an exhaust plenum 12, an exchangeable drum 14, and a cradle 16. The exchangeable cartridge system 10 of this invention is preferably constructed of stainless steel, such as HASTELLOY™, or another suitable material compatible with compounds and/or coating solutions used in coating operations. In a preferred embodiment, at least the exhaust plenum 12 and the exchangeable drum 14 are integrally formed as a one-piece unit in communication with each other and which can be connected and disconnected from the coater 100 as a single unit to decrease the changeover time and improve the cleanability of the drum 14. In a preferred embodiment, a plurality of rollers 17 may be positioned along the cradle 16 to permit the cradle 16 to slide in and out of the housing 102. In an embodiment of this invention, following removal of the exchangeable cartridge system from the housing, a different drum with a different production capacity with an exhaust plenum may be swapped onto the cradle 16 and placed in the production coater 100. In another embodiment, following removal of the exchangeable cartridge system, another exchangeable cartridge system with another cradle, drum and exhaust plenum may be positioned within and operationally connected to the production coater 100. Replacement of the exchangeable cartridge may be facilitated with a drive shaft decoupling, either manual or automated.

In an embodiment of this invention, the cradle 16 preferably accommodates a support 48 which may be integrated with the cradle 16. Alternatively, the support may be separate from the cradle and may be connected to the production coater as a trunion bar. The support is preferably configured to permit rotation of an access end of drum. In addition, the cradle 16 may include a slot or similar accommodation for a drive end of the drum 14, specifically a drive shaft or coupling.

FIG. 4 shows the exchangeable drum 14, according to one embodiment of this invention, separate from the exhaust plenum. In this embodiment, the drum 14 comprises a frusto-conical shape with an access end 18 having an annular opening providing access to an interior of the drum 14 and a drive end 20, connectable with the motor with a removeable coupling, on an opposite side of drum 14 from access end 18. However, the drum of this invention is not limited to this shape and may comprise any shape which allows the drum to coat pharmaceutical tablets and similar applications with a solution or a suspension. In the embodiment of FIG. 4, the drum 14 further includes a vented surface 22 and a plurality of baffles 24. The vented surface 22 preferably provides a means for expelling exhaust from the interior of the drum 14 to the exhaust plenum 12 without the cores being able to escape the drum. The baffles 24 improve the coating process. The drums of this invention may further include various levels of polishing, multiple perforation patterns, various perforation sizes and shapes and/or various types of mixing baffles and anti-slide bars. Such multiple configuration enable replaceable drums to match perforation size and shape to various substrates, processes and wash requirements; match perforation pattern to various structural requirements; and permit the processing of tablets, granules, beads, very small tablets and/or other objects. Drums may further include meshed perforations.

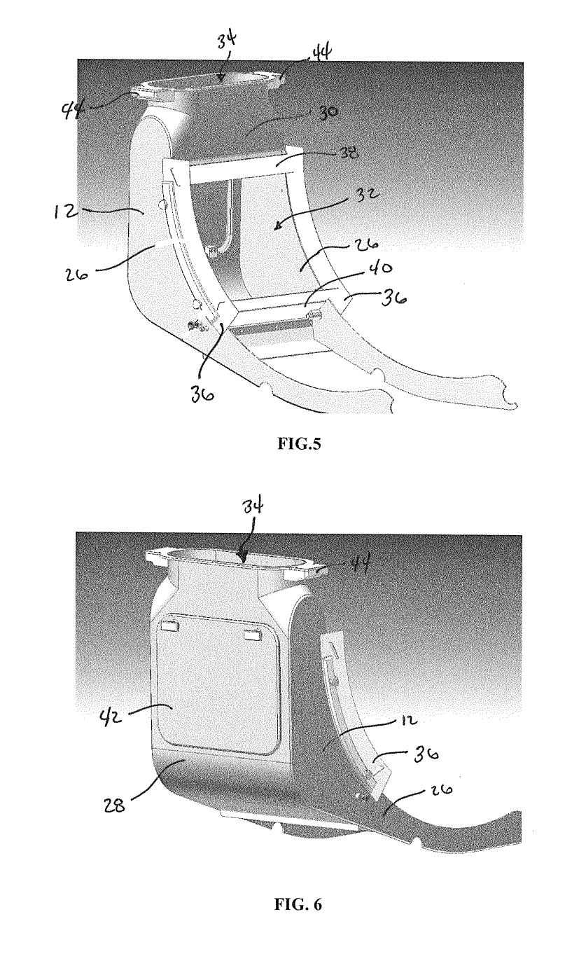

In an embodiment of this invention, the exhaust plenum 12 is connected to the drum 14 to provide a path for exhaust to be vented from an interior of the drum 14. FIGS. 5 and 6 show a preferred embodiment of the exhaust plenum 12 separate from the drum 14, the cradle 16 and the production coater 100. The exhaust plenum 12 preferably includes a pair of side walls 26, a rear wall 28 and a facing wall 30 that provide an enclosed path from the drum 14 to an exhaust duct. The pair of side walls 26, the rear wall 28 and the facing wall 30 form an opening 32 which faces the vented surface 22 of the drum 14. The walls 26, 28, 30 further enclose an exhaust path from the drum 14 to an exhaust opening 34. The exhaust opening 34 is preferably positioned on at least one of the pair of side walls 36, the rear wall 28, and the facing wall 30 to provide a connection to an exhaust duct. As best shown in FIG. 5, the opening 32 which faces the drum 14 is surrounded by a pair of side seals 36 and an upper seal 38 and a lower seal 40 to seal a gap between the exhaust plenum 12 and the drum 14 to prevent the exhaust plenum from bypassing air from outside of the drum 14 rather than through the drum perforations. In the embodiment of FIG. 5, the pair of side seals 36 and the upper seal 38 are fixed in position while the lower seal 40 is moveable to improve cleanability of the production coater 100 and to ensure proper water drainage during a washing cycle. However, it should be understood that any of the side seals 36, the upper seal 38 and the lower seal 40 may be fixed or moveable, as necessary.

As best shown in FIG. 6, the rear wall 28 may further include an inspection door 42 to facilitate cleaning and/or to facilitate inspection of the exhaust plenum 12 and the drum 14.

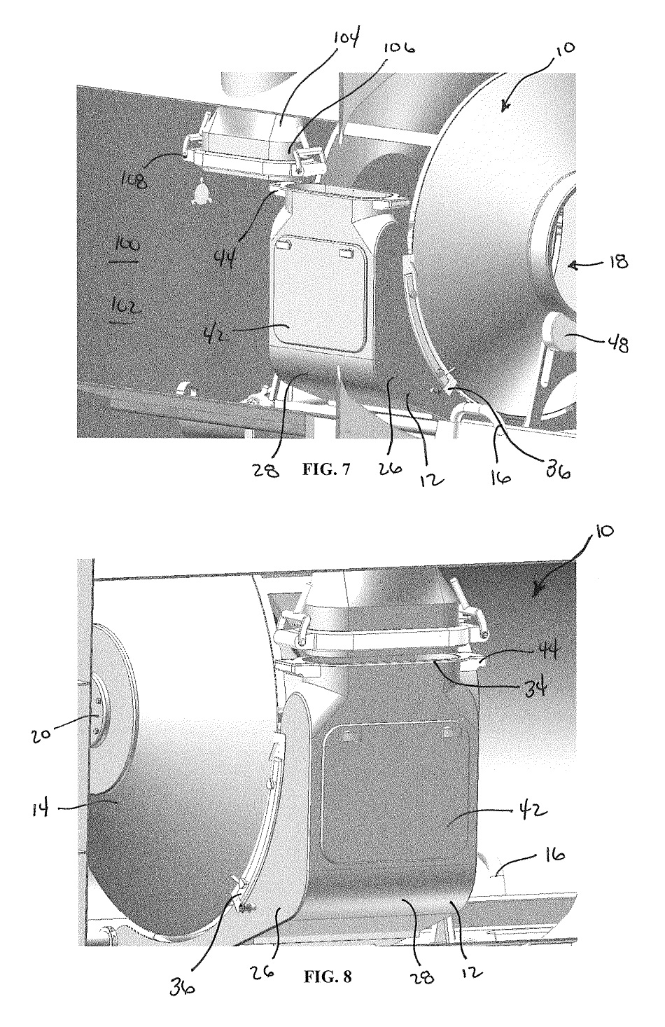

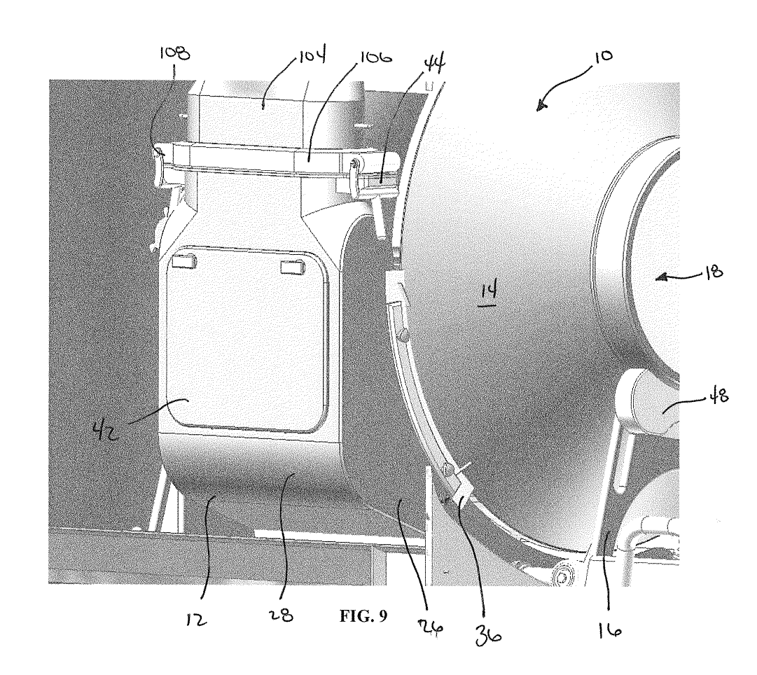

In an embodiment of this invention, the production coater 100 preferably includes an exhaust ductwork 104 with a connection sleeve 106 that can be easily connected and disconnected to the exhaust plenum 12 to facilitate changeover of the exchangeable cartridge system 10. FIGS. 7-9 show the steps for connecting the exhaust plenum 12 to the exhaust ductwork 104. In FIG. 7, the cradle 16 is rolled into the coater 100 until the exhaust opening 34 is aligned with the exhaust ductwork 104, as shown in FIG. 8. Once aligned, a pair of clamps 108 on the connection sleeve 106 are rotated downwards to engage a catch 44 on the side of the exhaust opening 34, as shown in FIG. 9, sealing the exhaust plenum 12 to the exhaust ductwork 34. The exhaust plenum 12 preferably connects to a vertical duct equipped with a manual or automated drain and, as such, does not drain directly into the coater, minimizing the risk of cross-contamination between exhaust ductwork 104, the drum 14 and the coater 100.

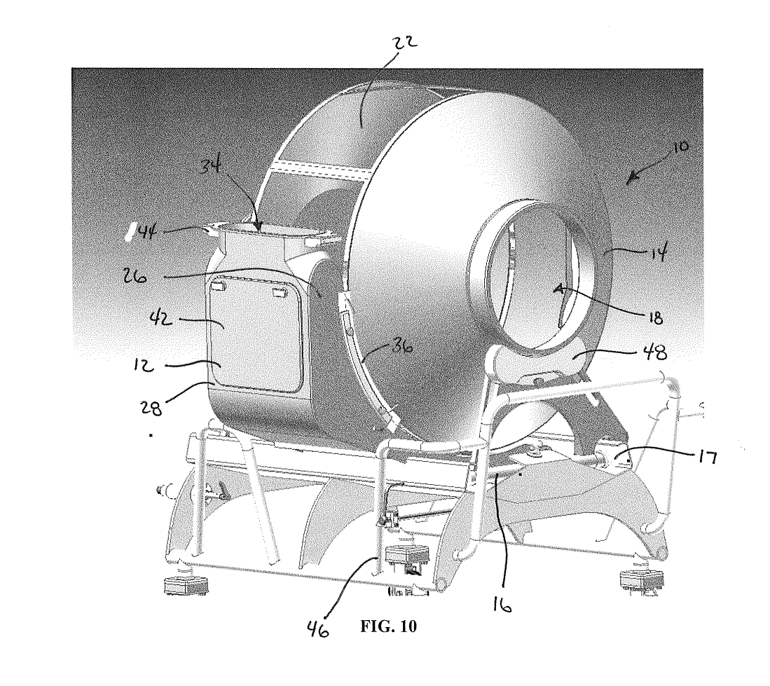

FIG. 10 shows another embodiment of this invention with the exchangeable cartridge system 10 positioned on a dolly 46 with a plurality of wheels. With this embodiment, the dolly 46 may be used to facilitate movement of the exchangeable cartridge 10.

According to a preferred embodiment of this invention, process support functions are integrated with coater 100. Such process support functions include: solution preparation; solution delivery; material handling; weight reconciliation; and/or power charging. This integration saves space and cost and permits single stop procurement while facilitating integrated automation. In addition, as described, the wash subsystems are preferably integrated with coater 100 including the coating chamber and drum; process air bypass; exhaust duct; spray bar; solution delivery; solution tanks; and/or a CoP sink.

Automation features may be additionally integrated including: air handling; coating; solution handling; material handling; inter-stage activities; and/or inter-run activities. Such functions are not currently automated in conventional coaters. Finally, control components may be integrated with the coater, specifically all control components may be preferably mounted at the back of the coater instead of being housed in several remote control enclosures.

While in the foregoing specification this invention has been described in relation to certain preferred embodiments thereof, and many details have been set forth for purpose of illustration, it will be apparent to those skilled in the art that the invention is susceptible to additional embodiments and that certain of the details described herein can be varied considerably without departing from the basic principles of the invention.

What is claimed is:

1. An exchangeable cartridge system for use with a production coater, the exchangeable cartridge system comprising:
a drum connectable to a motor of the production coater; and
an exhaust plenum connected in communication with the drum, the exhaust plenum including a pair of side walls and a rear wall forming a partially enclosed path from a drum-side opening to an exhaust opening, wherein the side walls conform to an outer curve of the drum at the drum-side opening, the rear wall extends between an edge of each of the pair of side walls and the exhaust opening surrounded by at least one of the pair of side walls and the rear wall.

2. The exchangeable cartridge system of claim 1, wherein the exhaust plenum further includes a side seal connected to at least one of the pair of side walls to at least partially seal a radial end of drum to the exhaust plenum.

3. The exchangeable cartridge system of claim 1, wherein the exhaust plenum further includes a horizontal seal positioned between the pair of side walls to at least partially seal an edge of the exhaust plenum near the drum-side opening when the exhaust plenum is adjacent to the drum.

4. The exchangeable cartridge system of claim 3, wherein the horizontal seal comprises an upper seal and a lower seal.

5. The exchangeable cartridge system of claim 4, wherein at least one of the upper seal and the lower seal is movable.

6. The exchangeable cartridge system of claim 1, further comprising:
a cradle supporting the exhaust plenum and drum, wherein the cradle, the exhaust plenum and the drum removably position within a housing of the production coater.

7. The exchangeable cartridge system of claim 6, wherein the cradle includes a plurality of rollers.

8. The exchangeable cartridge system of claim 1, wherein the rear wall of the exhaust plenum includes an inspection door.

9. The exchangeable cartridge system of claim 1, wherein the exhaust opening is formed at a top edge of the exhaust plenum.

10. The exchangeable cartridge system of claim 9 further comprising:
an exhaust ductwork in the production coater, the exhaust ductwork including a connection sleeve having a clamp, the connection sleeve connectable with the exhaust opening.

11. The exchangeable cartridge system of claim 1, wherein the drum comprises a capacity ranging from 30 liters to 1,200 liters.

12. A production coater with an exchangeable cartridge system comprising:
an exchangeable cartridge comprising a drum in communication with an exhaust plenum, the exhaust plenum including a pair of side walls and a rear wall forming a partially enclosed path with a drum-side opening and an exhaust opening, the exhaust plenum further including a side seal connected to at least one of the pair of side walls to at least partially seal an edge of the drum-side opening and a horizontal seal positioned between the pair of side walls to at least partially seal another edge of the drum-side opening when the exhaust plenum is adjacent to the drum;
a housing, wherein the exchangeable cartridge positionable within the housing;
a motor positioned within the housing, the drum removably connectable with respect to the motor to rotate the drum; and
an exhaust ductwork connectable with the exhaust opening of the exhaust plenum.

13. The production coater of claim 12, wherein the seal of the exhaust plenum comprises an upper and lower seal.

14. The production coater of claim 13, wherein the lower seal is movable.

15. The production coater of claim 12, wherein the rear wall of the exhaust plenum includes an inspection door.

16. The production coater of claim 12, wherein the exhaust opening is formed at a top edge of the exhaust plenum.

17. The production coater of claim 12, wherein the exchangeable cartridge includes a cradle to facilitate removal and replacement of the exchangeable cartridge.

18. The production coater of claim 17, wherein the exchangeable cartridge is replaceable with a replacement exchangeable cartridge having a different size drum.

19. The production coater of claim 15 further comprising:
a dolly slideably engageable with the cradle for removal and support of the cradle from the housing, the dolly including a plurality of wheels to permit the dolly to slide in and out of the housing.

20. The production coater of claim 12, further including:
a spray bar extending into a mixing chamber of the drum to coat a material with a solution or a suspension.
